(19) United States
(12) Patent Application Publication
(10) Pub. No.: US 2020/0410535 A1
(43) Pub. Date: Dec. 31, 2020

(54) METHODS AND APPARATUS FOR AUTOMATIC ITEM RECOMMENDATION

(71) Applicant: Walmart Apollo, LLC, Bentonville, AK (US)

(72) Inventors: Vimitha MANOHAR, Santa Clara, CA (US); Shirpaa MANOHARAN, Sunnyvale, CA (US); Kannan ACHAN, Saratoga, CA (US)

(21) Appl. No.: 16/456,830

(22) Filed: Jun. 28, 2019

(51) Int. Cl. G06Q 30/02; G06F 7/08

(52) U.S. Cl. CPC G06Q 30/0255; G06F 7/08

(57) ABSTRACT

This application relates to apparatus and methods for automatically identifying recommended items. In some examples, a computing device obtains item data identifying a plurality of items. The item data may identify online shopping cart items, for example. The computing device determines a plurality of values, such as probabilities, based on at least one attribute of the plurality of items, such as price. The computing device executes a stochastic process based on the plurality of values. For example, the computing device may execute a random walk process based on generated probabilities. The computing device may then generate an ordered listing based on execution of the stochastic process. For example, based on execution of the stochastic process, the computing device may identify one of the plurality of items, and include the identified item in the ordered listing. The computing device may then identify the recommended items based on the generated ordered listing.

### TECHNICAL FIELD

The disclosure relates generally to retail systems and, more specifically, to identifying recommended items for purchase.

### BACKGROUND

An advertisement may be a presentation or communication to promote an item, such as a product or service, for purchase. At least some advertisements are digital advertisements, which include a digital representation of the presentation or communication, such as one displayed on a website. For example, a retailer may display advertisements of items for sale on their website. In some examples, webpages of a website display advertisements as a user navigates the website. For example, as a user is viewing a webpage dedicated to information on a particular item, the webpage may display advertisements for one or more other items. The advertisements may allow a user to click on them, thereby taking the user to a webpage dedicated to the corresponding item.

In some examples, retailers may attempt to cross-sell items by presenting advertisements associated with current purchases. For example, the retailer's webpage may allow a user to add one or more items to an online shopping cart for purchase. When the user is ready to purchase the items, the user may select the online shopping cart, which may direct the user to an online shopping cart webpage. The online shopping cart webpage may allow the user to proceed with a checkout process that facilitates the purchase of the items. In some examples, retailers present advertisements on the online shopping cart webpage, in an attempt to increase their sales.

At least some sponsors of digital advertisements pay a fee to have an item advertised. For example, some sponsors of advertisements pay a fee to a retailer to advertise a sponsor's product on the retailer's website. For advertisements on a webpage, the amount of the fee may depend on a number of user interactions, such as user clicks, the advertisement receives.

However, not all customers that view an advertisement will click on the advertisement, much less purchase the advertised item. For example, a customer may not have an interest in the advertised item. Moreover, not all customers are interested in the same products. As such, it is beneficial to a retailer to provide on an advertising platform, such as the retailer's web site, digital advertisements of products that interest customers such that they are more likely to interact with the advertisement.

### SUMMARY

The embodiments described herein are directed to automatically providing advertisements, such as, for example, digital advertisements, on a website. The embodiments may select and provide for display digital advertisements of items that are more relevant to a customer such that the customer is more likely to purchase one or more of the advertised items. For example, the embodiments may select and provide for display digital advertisements for items that a particular customer is more likely to purchase based on items currently added to an online shopping cart. As a result, the embodiments may allow a retailer to increase their sales of items. For example, the embodiments may allow for higher conversion rates when customers select the advertisements. In some examples, retailers may increase fees collected from advertisers based on higher click rates for advertisements. Those of ordinary skill in the art would recognize additional advantages as well.

In accordance with various embodiments, exemplary systems may be implemented in any suitable hardware or hardware and software, such as in any suitable computing device. For example, in some embodiments, a computing device is configured to obtain item data identifying a plurality of items. The item data may identify online shopping cart items, for example. The computing device may determine a plurality of values based on at least one attribute of the plurality of items. In some examples, the plurality of values are probabilities, and the one attribute of the plurality of items is item price. In some examples, the one attribute is a cross-selling price, which may be a total price that includes the price of the item and the price(s) of other items sold with the original item. In some examples, the one attribute is an upselling price (e.g., the price of a more costlier version of the item). The computing device may execute a stochastic process based on the plurality of values. For example, the computing device may execute a random walk process based on generated probabilities. The computing device may then generate an ordered listing based on execution of the stochastic process. For example, based on execution of the stochastic process, the computing device may identify one of the plurality of items, and include the identified item in the ordered listing. The computing device may then identify a plurality of items based on the generated ordered listing. For example, based on the ordered listing, the computing device may identify a plurality of digital advertisements for items recommended to be purchased with the online shopping cart items.

In some embodiments, a method is provided that includes obtaining item data identifying a plurality of items, such as online shopping cart items, for example. The method may include determining a plurality of values based on at least one attribute of the plurality of items. The method may also include executing a stochastic process, such as a random walk process, based on the plurality of values. The method may further include generating an ordered listing based on execution of the stochastic process. For example, the method may include identifying one of the plurality of items, and including the identified item in the ordered listing. The method may also include identifying a plurality of items based on the generated ordered listing. For example, the method may include identifying a plurality of digital advertisements for items recommended to be purchased with the online shopping cart items.

In yet other embodiments, a non-transitory computer readable medium has instructions stored thereon, where the instructions, when executed by at least one processor, cause a computing device to perform operations that include obtaining item data identifying a plurality of items, such as online shopping cart items, for example. The operations may include determining a plurality of values based on at least one attribute of the plurality of items. The operations may also include executing a stochastic process, such as a random walk process, based on the plurality of values. The operations may further include generating an ordered listing based on execution of the stochastic process. For example, the operations may include identifying one of the plurality of items, and including the identified item in the ordered listing. The operations may also include identifying a plurality of items based on the generated ordered listing. For example, the operations may include identifying a plurality of digital advertisements for items recommended to be purchased with the online shopping cart items.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item advertisement system in accordance with some embodiments;

FIG. 2 is a block diagram of the item advertisement computing device of the item advertisement system of FIG. 1 in accordance with some embodiments;

FIG. 3A is an illustration of a transition matrix that may be generated by the item advertisement computing device of the item advertisement system of FIG. 1 in accordance with some embodiments;

FIG. 3B illustrates a random walk operation based on the transition matrix probabilities of FIG. 3A in accordance with some embodiments;

FIG. 4 is a block diagram illustrating examples of various portions of the item advertisement system of FIG. 1 in accordance with some embodiments;

FIG. 5A illustrates recommended item data identifying item advertisements that may be selected by the item advertisement computing device of the item advertisement system of FIG. 1 in accordance with some embodiments;

FIG. 5B illustrates an online shopping cart webpage with selected item advertisements of FIG. 5A in accordance with some embodiments;

FIG. 5C illustrates a digital advertisement list that may be displayed by the online shopping cart webpage of FIG. 5B in accordance with some embodiments;

FIG. 6 is a flowchart of an example method that can be carried out by the item advertisement system of FIG. 1 in accordance with some embodiments;

FIG. 7 is a flowchart of another example method that can be carried out by the item advertisement system of FIG. 1 in accordance with some embodiments; and

FIG. 8 is a flowchart of another example method that can be carried out by the item advertisement system of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

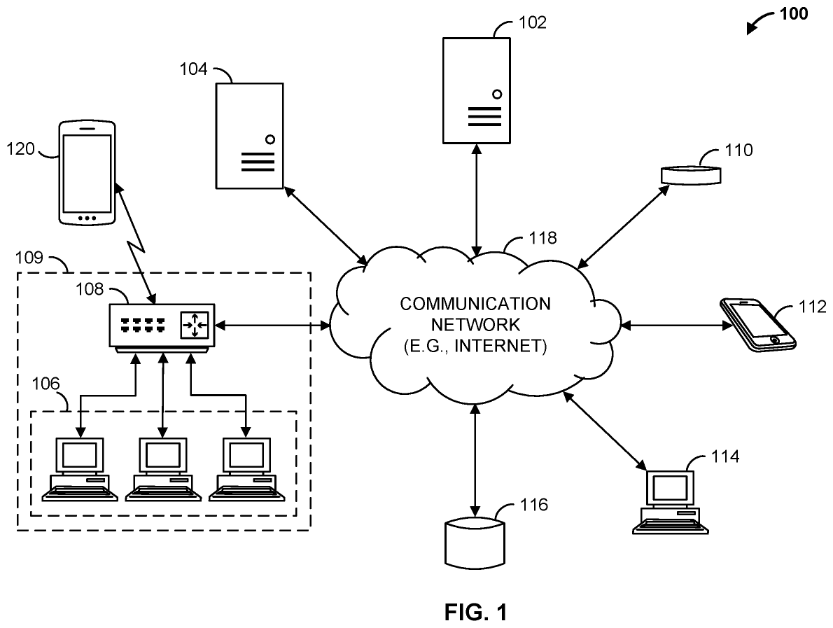

Turning to the drawings, FIG. 1 illustrates a block diagram of an item advertisement system 100 that includes an item advertisement computing device 102 (e.g., a server, such as an application server), a server 104 (e.g., a web server), workstation(s) 106, database 116, multiple customer computing devices 110, 112, 114, and associate computing device 120 communicatively coupled over network 118. Item advertisement computing device 102, workstation(s) 106, server 104, multiple customer computing devices 110, 112, 114, and associate computing device 120 can each be any suitable computing device that includes any hardware or hardware and software combination for processing and handling information. For example, each of item advertisement computing device 102, server 104, workstations 106, multiple customer computing devices 110, 112, 114, and associate computing device 120 can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

Item advertisement computing device 102 can be, for example, a computer, a workstation, a laptop, a server such as a cloud-based server, or any other suitable device. Each of multiple customer computing devices 110, 112, 114 and associate computing device 120 can be a mobile device such as a cellular phone, a laptop, a computer, a table, a personal assistant device, a voice assistant device, a digital assistant, or any other suitable device.

Although FIG. 1 illustrates three customer computing devices 110, 112, 114, item advertisement system 100 can include any number of customer computing devices 110, 112, 114. Similarly, item advertisement system 100 can include any number of workstation(s) 106, item advertisement computing devices 102, servers 104, associate computing devices 120, and databases 116.

Workstation(s) 106 are operably coupled to communication network 118 via router (or switch) 108. Workstation(s) 106 and/or router 108 may be located at a store 109, for example. Workstation(s) 106 can communicate with item advertisement computing device 102 over communication network 118. The workstation(s) 106 may send data to, and receive data from, item advertisement computing device 102. For example, workstation(s) 106 may transmit purchase order data, such as data identifying and characterizing purchases made at store 109, to item advertisement computing device 102. In response, workstation(s) may receive recommendation data, such as data identifying and characterizing one or more recommended items, from item advertisement computing device 102.

In some examples, workstation(s) 106 are communicatively coupled with one or more associate computing devices 120. Each associate computing device 120 may be operated by a retail associate of store 109. In some examples, associate computing device 120 requests a list of recommended items for an out of stock item from workstation(s) 106. Workstation(s) 106 may respond with the requested list, which identifies at least one recommend item. Workstation(s) 106 may also communicate with server 104. For example, server 104 may be a web server and host one or more web pages, such as a retailer's website. Workstation(s) 106 may be operable to access and program (e.g., configure) the webpages hosted by server 104, for example.

Item advertisement computing device 102 is operable to communicate with database 116 over communication network 118. For example, item advertisement computing device 102 can store data to, and read data from, database 116. Database 116 can be a remote storage device, such as a cloud-based server, a memory device on another application server, a networked computer, or any other suitable remote storage. Although shown remote to item advertisement computing device 102, in some examples, database 116 can be a local storage device, such as a hard drive, a non-volatile memory, or a USB stick.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, web server 104 may host one or more webpages of a website. Each of multiple computing devices 110, 112, 114 may be operable to view, access, and interact with the webpages hosted by web server 104. In some examples, web server 104 hosts a website for a retailer that allows for the purchase of items. The website may include one or more web pages. For example, the website may include a webpage that shows items a customer has selected for purchase (e.g., online shopping cart webpage). An operator of one of multiple computing devices 110, 112, 114 may access the website hosted by web server 104, add one or more items to an online shopping cart of the web page (which may be viewed on the online shopping cart webpage by selecting an online shopping cart icon), and perform an online checkout of the shopping cart to purchase the items. Web server 104 may store data related to the order, such as an order number, and prices and item identification numbers of purchased items, in database 116. In some examples, the web page allows a delivery option or pickup option of the order. For example, the delivery option provides for the delivery of the order at a specified delivery address by a particular date. The pickup option allows the customer to pick up the order at a retail location.

In some examples, item advertisement computing device 102 may identify and provide one or more advertisements, such as digital advertisements, based upon one or more items that a user has added to an online shopping cart. To identify the advertisements, item advertisement computing device 102 may generate a transition matrix based on the items in the online shopping cart. Each transition matrix identifies probabilities based on any number of (e.g., two) of the items in the online shopping cart. For example, the transition matrix probabilities may be based on the price of each of two online shopping cart items. The transition matrix probability corresponding to one online shopping cart item as to another online shopping cart item may be determined based on the percentage of the price of the one online shopping cart item to the total price for both the one online shopping cart item and the other online shopping cart item. For example, the probability for one online shopping cart item to another online shopping cart item may be determined based on the equation below:

pₐ=price(a)Σₖ₌₀ⁿprice(k); (eq. 1)
where:
pₐ=transition matrix probability for item a;
n=number of items for the transition matrix, including item a
price(a)=price of item a;
price(k)=price of each item for the transition matrix;

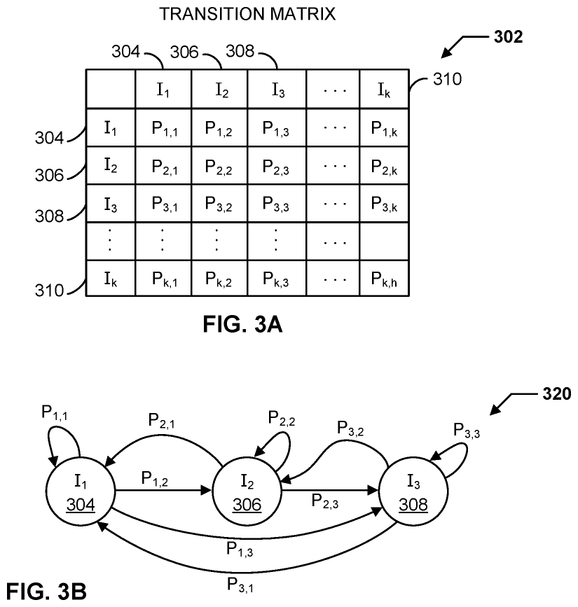

In one example, the transition matrix probability for one online shopping cart item to another online shopping cart item may be based on how likely the other online shopping cart item will be purchased if the first online shopping cart item is purchased. For example, the transition matrix probabilities may be based on historical purchase data, such as how often (e.g., what percentage of purchases) a first online shopping cart item is purchased when a second online shopping cart item is purchased. In some examples, the transition matrix probabilities may be determined based on one or more machine learning models, such as machine learning models trained with historical purchase data. The transition matrix probabilities may be determined in other suitable manners as well. FIG. 3A illustrates an example transition matrix, and is described further below.

Item advertisement computing device 102 may generate a list of recommended items for each item a retail sells (referred herein as an “anchor” item), for example. For each anchor item, the recommended items may be based on historical purchase data, such as how often (e.g., what percentage of purchases) a recommended item is purchased along with the corresponding anchor item. The list may rank recommended items in an order of relevance. For example, recommended items that are purchased more often with the anchor item may appear before recommended items that are purchased less often with the anchor item. The list of recommended items may also be generated based on a retailer identifying what items should be recommend for each anchor item, or in in any other suitable way. Item advertisement computing device 102 may store the list of recommended items for each anchor item in database 116, for example.

Based on the generated transition matrices, item advertisement computing device 102 may execute one or more stochastic or random processes (e.g., algorithms) to identify (e.g., select) which recommended items to advertise (e.g., advertise on an online shopping cart page, or home page, of a retailer's website). Item advertisement computing device 102 may identify one or more recommended items corresponding to one or more online shopping cart items. For example, assuming there are three items added to an online shopping cart, based on execution of the one or more stochastic or random processes, item advertisement computing device 102 may determine that the following recommended items, in order, be advertised: a first recommended item for the first cart item; a second recommended item for the first cart item; a first recommended item for the second cart item; a third recommended item for the first cart item; a second recommended item for the second cart item; and a first recommended item for the third cart item.

In some examples, the stochastic or random process is based on a random walk algorithm that identifies recommended items for any corresponding online shopping cart items based on the generated transition matrix probabilities. In some examples, after a maximum number of recommended items for a corresponding online shopping cart item are selected by item advertisement computing device 102, no further recommended items will be selected for that corresponding online shopping cart item until the maximum number of recommended items are selected for each online shopping cart item. Once the maximum number of recommend items are selected for each online shopping cart item, item advertisement computing device 102 may execute the stochastic or random process to select additional recommended items for each of the online shopping cart items. FIG. 3B illustrates an example of a random walk operation based on transition matrix probabilities, and is described further below.

Item advertisement computing device 102 may transmit a message identifying the selected recommended items to advertise. For example, item advertisement computing device 102 may transmit a message to web server 104 identifying and characterizing the recommended item to advertise. Web server 104 may then select a digital advertisement for the identified item, and provide the digital advertisement for display on a web page, such as on online shopping cart web page. In some examples, item advertisement computing device 102 selects and provides the digital advertisement for the selected recommended item to web server 104 for display.

In some examples, item advertisement computing device 102 may determine item recommendations based on items purchased in a store. For example, workstations 106 may transmit purchase order data identifying a purchase order made at store 109. Item advertisement computing device 102 may determine one or more item recommendations based on the items in the purchase order, and provide recommendation data identifying one or more recommended items to workstations 106. The retailer may provide the customer a list of the items, such as at checkout, for purchase consideration. In one example, the retailer provides a receipt to the customer for the purchase order that identifies (e.g., shows a picture and/or description of) the recommended items. Even more generally, item advertisement computing device 102 may identify and provide one or more ranked item sets that identify items in a ranked order based on a current list of items.

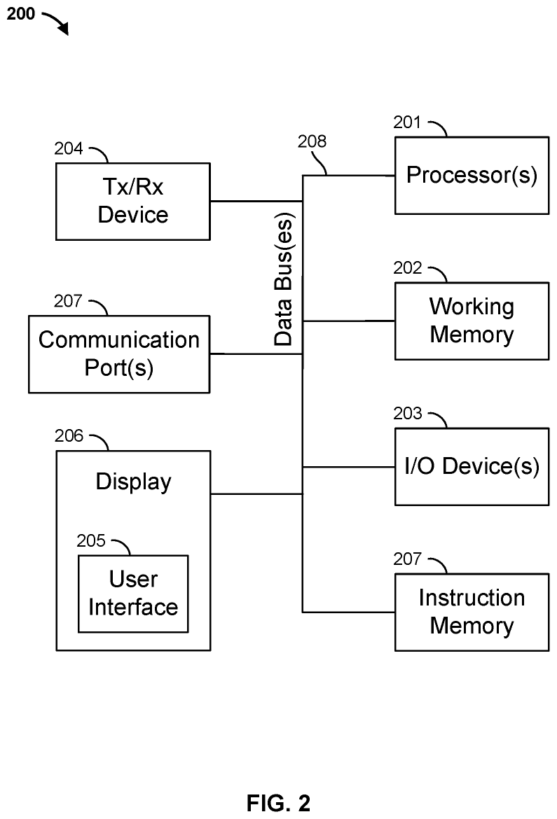

FIG. 2 illustrates an example of the item advertisement computing device 102 of FIG. 1. Item advertisement computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item advertisement computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as item substitution data.

Display 206 can display user interface 205. User interfaces 205 can enable user interaction with item advertisement computing device 102. For example, user interface 205 can be a user interface for an application of a retailer that allows a customer to initiate the return of an item to the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item advertisement computing device 102 will be operating in. Processor(s) 201 is operable to receive data from, or send data to, a network, such as communication network 118 of FIG. 1, via transceiver 204.

FIG. 3A illustrates an example transition matrix 302 that may be generated by item advertisement computing device 102. In this example, an assumption that first item 304, second item 306, third item 308, and up to a k^{th} item 310 have been added to an online shopping cart. Item advertisement computing device 102 generates a probability (indicated by “P_{a,b}” where “a” represents the row and “b” represents the column of the transition matrix) for each combination of two of the items, as indicated. The probabilities may be generated based on the price of each of the two items corresponding to each probability. For example, probability “P_{1,2}” may be based on the price of first item 304 with respect to second item 306. Similarly, probability “P_{2,3}” may be based on the price of second item 306 with respect to third item 308.

In some examples, item advertisement computing device 102 generates transition matrix 302 in real-time. For example, web server 104 may transmit an online cart activity message to item advertisement computing device 102 identifying items currently in an online shopping cart. Based on the items identified in the online cart activity message, item advertisement computing device 102 may generate a transition matrix. In some examples, web server 104 transmits an online cart activity message to item advertisement computing device 102 when items in the online shopping cart are updated. For example, if a customer adds an item to the shopping cart, web server 104 transmits an online cart activity message to item advertisement computing device 102 identifying the items. If the customer removes an item from the online shopping cart, web server 104 sends another online cart activity message to item advertisement computing device 102 identifying the remaining items in the online shopping cart.

Upon receiving each online cart activity message, item advertisement computing device 102 generates transition matrix 302 and may determine one or more item advertisement recommendations to provide to web server 104. For example, upon generating transition matrix 302, item advertisement computing device 102 may execute, based on the transition matrix probabilities, one or more stochastic or random processes, such as a random walk algorithm, to identify recommended items to digitally advertise. Item advertisement computing device 102 may transmit an item advertisement recommendation message to web server 104 that identifies the recommended items to advertise.

FIG. 3B illustrates a random walk operation based on the transition matrix probabilities of FIG. 3A. This example assumes that only first item 304, second item 306, and third item 308 are currently in the online shopping cart. To generate a list of recommended items to advertise, item advertisement computing device 102 may select a first recommended item from any of the recommended items for first item 304, second item 306, and third item 308. The first recommended item may be the highest ranked recommended item for the highest priced item between first item 304, second item 306, and third item 308, for example. In some examples, the first recommended item is randomly chosen from all recommended items for the first item 304, second item 306, and third item 308. Assume, in this example, that the first recommended item is selected as a recommended item for first item 304.

Item advertisement computing device 102 may then execute the random walk algorithm based on the probabilities identified in transition matrix 302. Because the first recommended item was selected for first item 304, the random walk algorithm executes with a probability of P_{1,1} that the next recommended item will also be for first item 304, a probability of P_{1,2} that the next recommended item will be for second item 306, and a probability of P_{1,3} that the next recommended item will be for third item 308. Multiple iterations of the random walk algorithm may be executed until a predefined number of recommended items have been selected.

For example, assuming that execution of a first iteration of the random walk algorithm results in first item 304 being selected, a second recommended item for first item 304 is identified. Assuming that execution of a second iteration of the random walk algorithm results in second item 306 being selected, a first recommended item for second item 306 is identified. Assuming that execution of a third iteration of the random walk algorithm results in first item 304 being selected again, a third recommended item for first item 304 is identified. Assuming that execution of a fourth iteration of the random walk algorithm results in second item 306 being selected, a second recommended item for second item 306 is identified, and so forth. In some examples, once an item (e.g., first item 304, second item 306, or third item 308) has been selected a maximum number of times (e.g., three), no additional recommended items for that item will be identified. For example, if first item 304 has been selected the maximum number of times, any further iterations of the random walk algorithm that result in first item 304 will be ignored, until at least the other items (e.g., second item 306, third item 308) have been selected the maximum number of times.

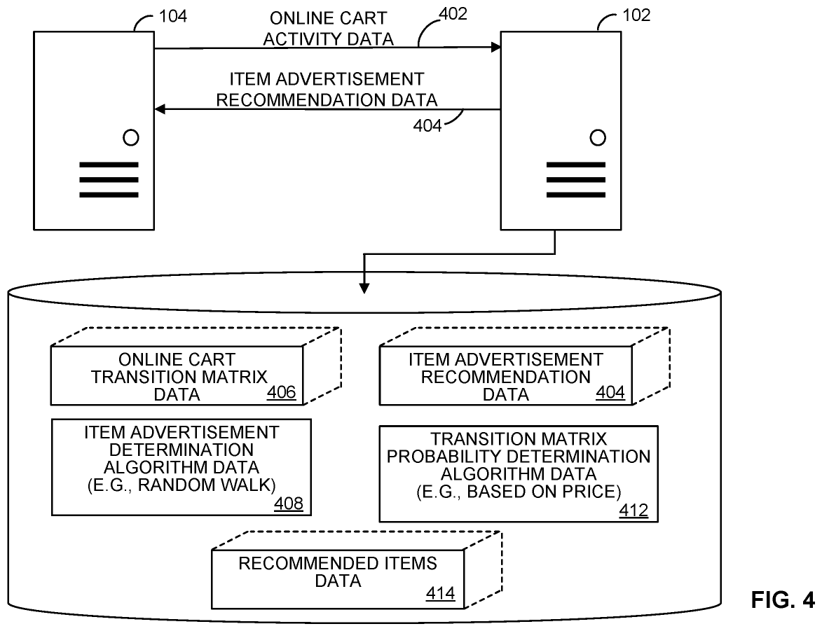

FIG. 4 is a block diagram illustrating examples of various portions of the item advertisement system 100 of FIG. 1. In this example, web server 104 provides online cart activity data 402 to item advertisement computing device 102. Online cart activity data 402 may identify items in an online shopping cart, such as an online shopping cart of a retailer's website. In some examples, web server 104 provides online cart activity data 402 in real-time, e.g., as a customer adds or removes items from the online shopping cart. In response to online cart activity data 402, item advertisement computing device 102 may generate a transition matrix identifying probabilities based on the items identified by online cart activity data 402. For example, the transition matrix probabilities may be generated based on the price of the identified items. Item advertisement computing device 102 may obtain from database 116 transition matrix probability determination algorithm data 412 which identifies and characterizes an algorithm to generate the transition matrix. Item advertisement computing device 102 generates the transition matrix based on execution of transition matrix probability determination algorithm data 412. Item advertisement computing device 102 may store online cart transition matrix data 406 in database 116, which identifies and characterizes the generated transition matrix.

Item advertisement computing device 102 may obtain and execute item advertisement determination algorithm data 408, which identifies and characterizes one or more stochastic or random processes, such as a random walk process, to identify recommended items to advertise. Item advertisement computing device 102 may execute item advertisement determination algorithm data 408 based on the probabilities identified by online cart transition matrix data 406 to identify one or more recommended item advertisements. For example, recommended items data 414, stored in database 116, identifies one or more recommended items for a plurality of items. Item advertisement computing device 102 may obtain from database 116 the recommended items for each online shopping cart item identified by online cart activity data 402. Based on execution of item advertisement determination algorithm data 408, item advertisement computing device 102 may select one or more of the obtained recommended items for the online shopping cart items identified by online cart activity data 402. Item advertisement computing device 102 may store item advertisement recommendation data 404, which identifies and characterizes the selected recommended items, in database 116. Item advertisement computing device 102 may also provide item advertisement recommendation data 404 to web server 104 in response to receiving online cart activity data 402. In some examples, item advertisement recommendation data 404 identifies digital advertisements to be displayed on an online shopping cart webpage served by web server 104.

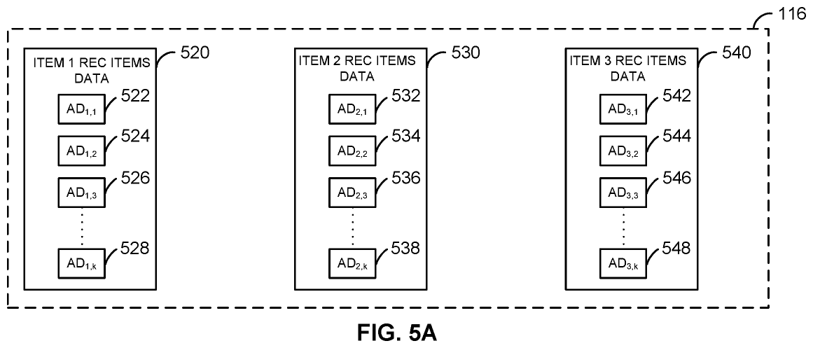

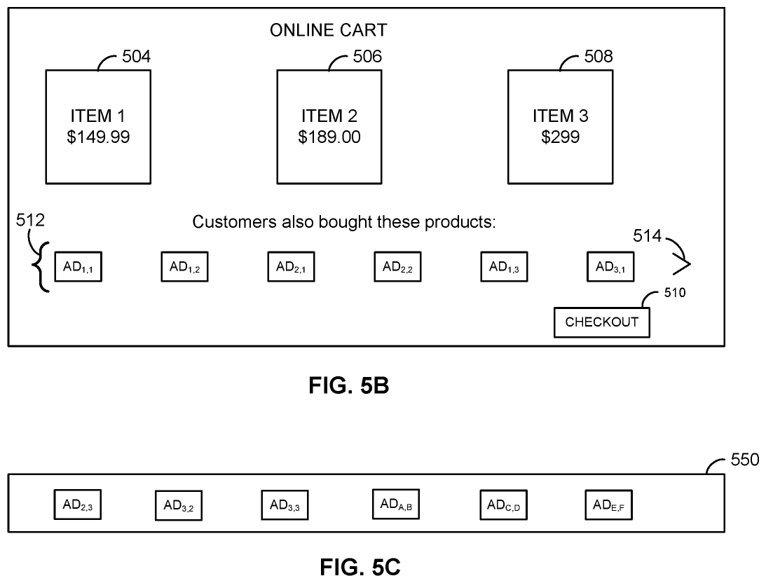

FIG. 5A illustrates recommended item data identifying item advertisements that may be selected by item advertisement computing device 102. First item recommendation items data 520 may include a plurality of digital advertisements for corresponding recommended items for a first item. For example, if first item is a tent, the plurality of digital advertisements may advertise camping equipment, such as an inflatable bed, a lantern, or fishing gear, for example. In this example, first item recommendation items data 520 includes digital advertisement 522, 524, 526, and up to digital advertisement 528. Second item recommendation items data 530 includes digital advertisement 532, 534, 536, and up to digital advertisement 538 for corresponding recommended items for a second item. Similarly, third item recommendation items data 540 includes digital advertisement 542, 544, 546, and up to digital advertisement 548 for corresponding recommended items for a third item.

Assuming a customer has added the first item, second item, and third item to an online shopping cart, item advertisement computing device 102 may generate transition matrix probabilities based on the first item, second item, and third item. Item advertisement computing device 102 may then execute a random walk operation based on the generated transition matrix probabilities to identify which digital advertisements are to be displayed, such as on an online shopping cart web page.

FIG. 5B illustrates an example online shopping cart webpage 502 with digital advertisements 512 of FIG. 5A. As illustrated, the online shopping cart includes a first item 504, a second item 506, and a third item 508. Online shopping cart webpage 502 also illustrates recommended items, which includes the digital advertisements 512 from FIG. 5A. In this example, item advertisement computing device 102 identified, in order: the first digital advertisement of first item recommendation items data 520; the second digital advertisement of first item recommendation items data 520; the first digital advertisement of second item recommendation items data 530; the second digital advertisement of second item recommendation items data 530; the third digital advertisement of first item recommendation items data 520; and the first digital advertisement of third item recommendation items data 540. In this example, only six recommendations are displayed at once. In some examples, any other number of digital advertisements may be displayed.

In some examples, item advertisement computing device 102 identifies more digital advertisements than can be displayed at once. For example, as illustrated in FIG. 5C, item advertisement computing device 102 may generate a digital advertisement list 550 that identifies additional digital advertisements as selected in accordance with the random walk operation. The digital advertisements of digital advertisement list 550 may be displayed if a user engages (e.g., selects) additional recommendation icon 514. For example, upon selection of additional recommendation icon 514, the current six digital advertisements may be removed from the online shopping cart webpage 502, and the next six digital advertisements of digital advertisement list 550 may be displayed.

As an example, assume that up to three digital advertisements may be identified for any one online shopping cart item. Once three digital advertisements are identified for any one item, only digital advertisements for remaining online shopping cart items may be identified. Assume that, in accordance with a stochastic or random process (e.g., random walk operation), item advertisement computing device 102 identifies the digital advertisements illustrated in FIG. 5B. After the third digital advertisement of first item recommendation items data 520 is identified, if the stochastic or random process selects the first item, the selection is ignored until three digital advertisements are identified for each of the first, second, and third items. As illustrated in FIG. 5C, after the first digital advertisement of third item recommendation items data 540 is identified (shown in FIG. 5B), the third digital advertisement of second item recommendation items data 530 is selected as illustrated in digital advertisement list 550. Thereafter, because three recommended items have been identified for the first item and the second item, only recommend items for the third item may be identified. In this example, the second digital advertisement of third item recommendation items data 540 is identified, followed by the third digital advertisement of third item recommendation items data 540, as illustrated digital advertisement list 550. Because the maximum number of digital advertisements, in this example, three, have been selected for all online shopping cart items, item advertisement computing device 102 may now select recommendation items for any of the online shopping cart items. This is illustrated by the remaining digital advertisements in the digital advertisement list 550.

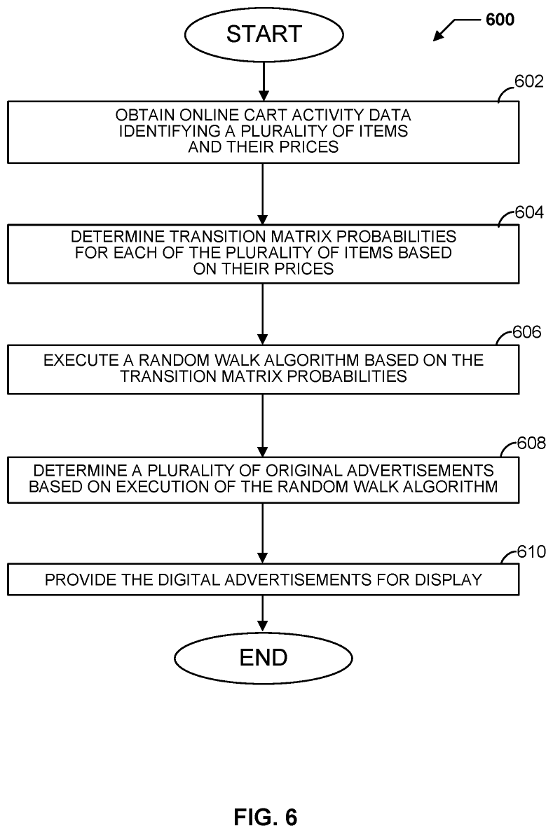

FIG. 6 a flowchart of an example method 600 that can be carried out by the item advertisement system 100 of FIG. 1. Beginning at step 602, online cart activity data is obtained. The online cart activity identifies a plurality of items and their corresponding prices (e.g., item price, cross-selling price, upselling price, etc.). For example, the online cart activity may identify items in an online shopping cart. At step 604, transition matrix probabilities are determined for each of the plurality of items based on their corresponding prices. For example, a higher probability may be determined for an item priced higher than for a lower priced item. Proceeding to step 606, a random walk algorithm is executed based on the transition matrix probabilities. Execution of the random walk algorithm may generate a ranked list of selected items of the plurality of items, where each item may be selected up to a maximum number of times. At step 608, a plurality of digital advertisements are determined based on the execution of the random walk algorithm. For example, a recommended digital advertisement for each selected item in the ranked list may be identified. At step 610, the digital advertisements are provided for display.

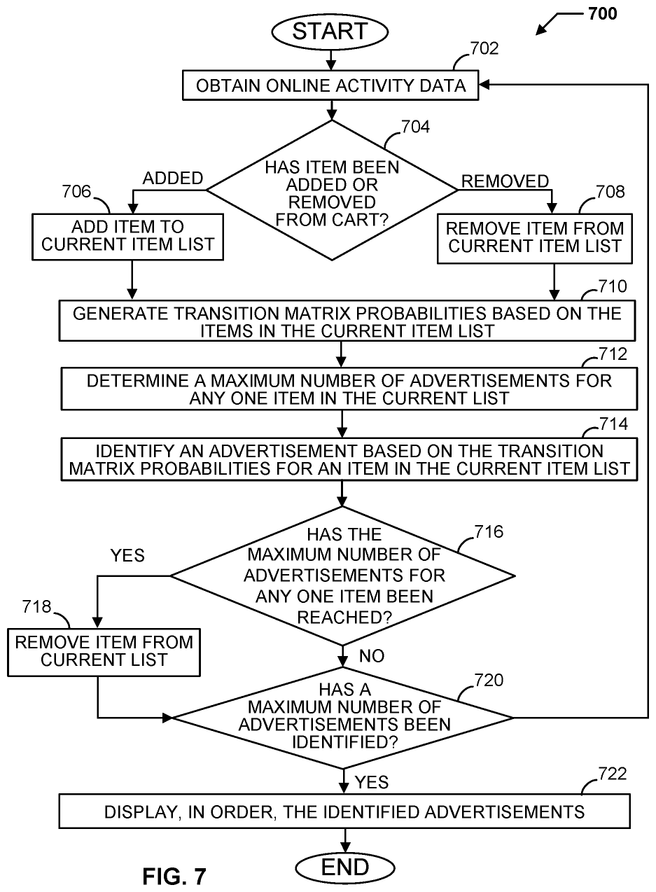

FIG. 7 is a flowchart of another example method 700 that can be carried out by the item advertisement system 100 of FIG. 1. Beginning at step 702, online cart activity data is obtained. The online cart activity may identify a plurality of items and their corresponding prices. For example, the online cart activity may identify items in an online shopping cart. At step 704, a determination is made as to whether an item has been added, or removed, from the online shopping cart. For example, item advertisement computing device 102 may compare a list of items identified from previously obtained online cart activity data to the currently obtained online cart activity data to determine whether an item has been added or removed from the online shopping cart. If an item has been added to the online shopping cart, the method proceeds to step 706, where the item is added to a current item list. If, however, and item has been removed from the online shopping cart, the method proceeds to step 708, where the removed item is removed from the current item list. From steps 706 and 708, the method proceeds to step 710.

At step 710, transition matrix probabilities are generated based on the items in the current item list. For example, the transition matrix probabilities may be generated based on the prices of the items in the current item list. Proceeding to step 712, a maximum number of advertisements for any one item in the current item list is determined. In some examples, a user configures the maximum number of advertisements by providing input via input/output device 203. In some examples, the maximum number of advertisements is obtained from database 116. At step 714, an advertisement is identified for an item in the current item list based on the transition matrix probabilities. For example, item advertisement computing device 102 may execute a stochastic or random process based on the transition matrix probabilities to select an item in the current item list. Item advertisement computing device 102 may then identify a recommended item advertisement for the selected item in the current item list.

Proceeding to step 716, a determination is made as to whether the maximum number of advertisements for any one item in the current item list has been reached. If the maximum number of advertisements for one item has been reached, the method proceeds to step 718, where the item is removed from the current item list. The method then proceeds to step 720. Otherwise, if at step 716 the maximum number of advertisements for no items in the current item list has been reached, the method proceeds to step 720.

At step 720, a determination is made as to whether a maximum number of advertisement have been identified. If the maximum number of advertisements have not been identified, the method proceeds back to step 702 to await additional online activity data. Otherwise, if the maximum number of advertisements have been identified, the method proceeds to step 722. At step 722, the identified advertisements are displayed in order. For example, a portion of the maximum number of advertisements are displayed at once, with additional advertisements being displayed upon receiving an input from a user, such as an engagement of additional recommendation icon 514.

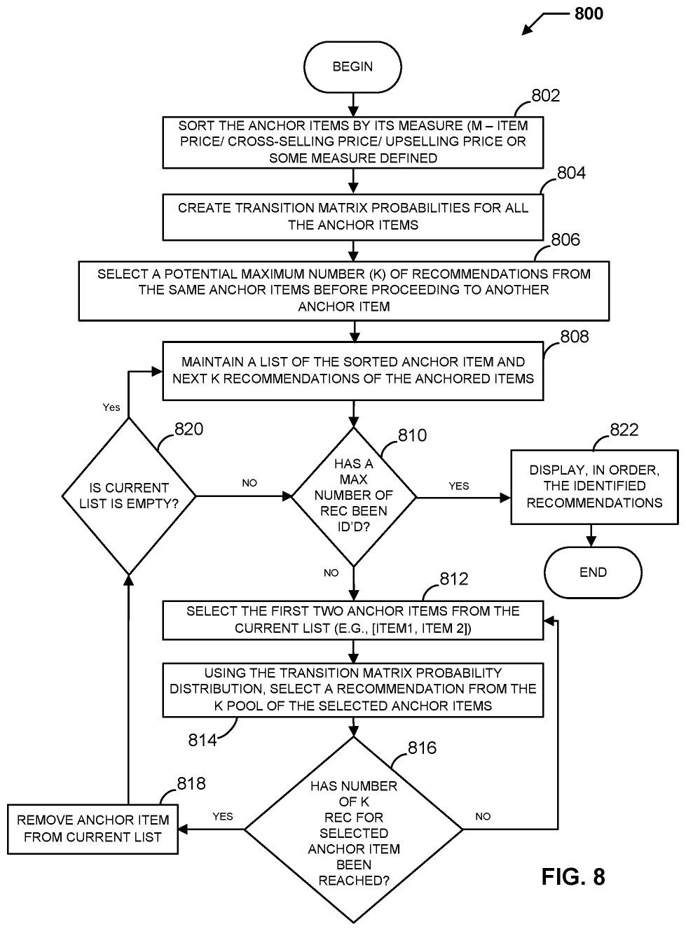

FIG. 8 is a flowchart of another example method 800 that can be carried out by the item advertisement system 100 of FIG. 1. Beginning at step 802, anchor items are ranked by a measure, such as price, or some other measure. At step 804, transition matrix probabilities are generated for all of the anchor items. At step 806, a selection is made as to a maximum number (e.g., k) of recommendations (e.g., advertisements) that may be made for any one anchor item, such that no more than the maximum number of recommendations may be selected for any given anchor item. In some examples, the maximum number of recommendations is a predefined number which may be user configurable. At step 808, a list is maintained that identifies the sorted anchor items and recommendations for the anchor items (up to the selected maximum number).

Proceeding to step 810, a determination is made as to whether a maximum number of recommendations (i.e., a total number of recommendations, regardless of anchor item) have been identified for all of the anchor items. If the maximum number of recommendations have been identified, the method proceeds to step 822, where the identified recommendations are displayed. The method then ends.

If, however, at step 810 the maximum number of recommendations have not been identified, the method proceeds to step 812. At step 812, a number of anchor items (in this example, two), are selected from the list. At step 814, recommendations for the selected anchor items are determined based on the transition matrix probabilities corresponding to the selected anchor items. In some examples, the recommendation with the highest probability is chosen. In some examples, a recommendation is chosen at random. Proceeding to step 816, a determination is made as to whether the maximum number of recommendations (e.g., k) for any currently selected anchor item (e.g., in this example, the two currently selected anchor items) has been selected. If the maximum number of recommendations have not been selected for any of the currently selected anchor items, the method proceeds back to step 812.

Otherwise, if the maximum number of recommendations have been selected for any of the currently selected anchor items, the method proceeds to step 818, where the anchor item for which the maximum number of recommendations have been selected is removed from the list. From step 818, the method proceeds to step 820, where a determination is made as to whether the list is empty, i.e., there are no more anchor items. If the list is empty, the method proceeds back to step 808, where a new list is generated. Otherwise, if the list is not empty, the method proceeds back to step 810.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain item data identifying a plurality of items;
determine a plurality of values based on at least one attribute of the plurality of items;
execute a stochastic process based on the plurality of values;
generate an ordered listing based on execution of the stochastic process; and
identify a plurality of items based on the generated ordered listing.

2. The system of claim 1 further comprising determining subsets of the plurality of items, wherein determining the plurality of values based on at least one attribute of the plurality of items comprises generating a probability for each subset of the plurality of items based on a price for each item of each subset of the plurality of items.

3. The system of claim 2 wherein each subset of the plurality of items comprises two items, and wherein generating the probability for each subset of the plurality of items comprises generating a transition matrix identifying one probability for each subset of the plurality of items.

4. The system of claim 3 wherein each probability for each subset is generated based on pₐ=price(a)/Σₖ₌₀ⁿprice(k), where n is determined to be equal to a number of items in each subset.

5. The system of claim 1 wherein executing the stochastic process based on the plurality of values comprises executing a random walk algorithm based on the plurality of values.

6. The system of claim 5 wherein generating the ordered listing based on execution of the stochastic process comprises identifying, for each of a plurality of iterations of execution of the stochastic process, one of the plurality of items, and adding the identified item to the ordered listing.

7. The system of claim 6 further comprising determining that the identified item has been not yet been added to the ordered listing a maximum number of times.

8. The system of claim 7 further comprising executing the plurality of iterations of the stochastic process until each of the plurality of items has been added to the ordered listing the maximum number of times.

9. The system of claim 1 further comprising transmitting an indication of the identified plurality of items to another computing device.

10. A method comprising:
obtaining item data identifying a plurality of items;
determining a plurality of values based on at least one attribute of the plurality of items;
executing a stochastic process based on the plurality of values;
generating an ordered listing based on execution of the stochastic process; and
identifying a plurality of items based on the generated ordered listing.

11. The method of claim 10 further comprising determining subsets of the plurality of items, wherein determining the plurality of values based on at least one attribute of the plurality of items comprises generating a probability for each subset of the plurality of items based on a price for each item of each subset of the plurality of items.

12. The method of claim 11 wherein each subset of the plurality of items comprises two items, and wherein generating the probability for each subset of the plurality of items comprises generating a transition matrix identifying one probability for each subset of the plurality of items.

13. The method of claim 10 wherein executing the stochastic process based on the plurality of values comprises executing a random walk algorithm based on the plurality of values.

14. The method of claim 13 wherein generating the ordered listing based on execution of the stochastic process comprises identifying, for each of a plurality of iterations of execution of the stochastic process, one of the plurality of items, and adding the identified item to the ordered listing.

15. The method of claim 14 further comprising determining that the identified item has been not yet been added to the ordered listing a maximum number of times.

16. The method of claim 15 further comprising executing the plurality of iterations of the stochastic process until each of the plurality of items has been added to the ordered listing the maximum number of times.

17. A non-transitory computer readable medium having instructions stored thereon, wherein the instructions, when executed by at least one processor, cause a device to perform operations comprising:
obtaining item data identifying a plurality of items;
determining a plurality of values based on at least one attribute of the plurality of items;
executing a stochastic process based on the plurality of values;
generating an ordered listing based on execution of the stochastic process; and
identifying a plurality of items based on the generated ordered listing.

18. The non-transitory computer readable medium of claim 17 further comprising instructions stored thereon that, when executed by at least one processor, further cause the device to perform operations comprising determining subsets of the plurality of items, wherein determining the plurality of values based on at least one attribute of the plurality of items comprises generating a probability for each subset of the plurality of items based on a price for each item of each subset of the plurality of items.

19. The non-transitory computer readable medium of claim 18 further comprising instructions stored thereon that, when executed by at least one processor, further cause the device to perform operations comprising generating a transition matrix identifying one probability for each subset of the plurality of items.

20. The non-transitory computer readable medium of claim 17 further comprising instructions stored thereon that, when executed by at least one processor, further cause the device to perform operations comprising executing a random walk algorithm based on the plurality of values.
